(19) United States
(12) Patent Application Publication
(10) Pub. No.: US 2011/0225627 A1
(43) Pub. Date: Sep. 15, 2011

(54) Access Limited Search Results

(75) Inventors: Yuki UCHIDA, West Caldwell, NJ (US); Shun TANAKA, West Caldwell, NJ (US); Kazuhiko KATO, West Caldwell, NJ (US)

(73) Assignee: RICOH COMPANY, LTD., Tokyo (JP)

(21) Appl. No.: 12/722,374

(22) Filed: Mar. 11, 2010

(51) Int. Cl. G06F 21/00

(52) U.S. Cl. 726/3

(57) ABSTRACT

Apparatuses, systems and methods are provided for accessing a document management application through a network, wherein search results provided to an application user, via a user interface, do not include documents or document data that are not within the extent of the data accessible by the specific user.

### TECHNICAL FIELD

This disclosure relates to systems, apparatuses and methodologies for managing and exchanging documents and files.

### BACKGROUND

In the current information age, information technology (IT) tools for managing files and data are extensively used in enterprises and other organizations, in order to store and transfer electronic documents and data over a network.

A document management system (for example, DocumentMall) can provide users with remote access (that is, through a network) to software applications and related services that would otherwise have to be installed on the user's local computer. For example, such a document management system may be configured to store documents as electronic files in a network-connected (and secure) document storage device, in order to protect the documents from theft or loss and to avoid unnecessarily occupying storage space local to the user computer or local computing environment, while making such files available on demand. The documents may include voluminous and/or sensitive material, and may be configured to provide searchable databases of all forms of legal, medical, financial, educational, scientific, and marketing documents for individuals and/or companies via a network.

A conventional document management system typically includes a search function configured to receive user input of search key terms. The conventional document management system searches the document data in a document storage part of the document management system based on the search key terms, and retrieves the corresponding data from the document storage part of the document management system. The document management system then transmits the search results to the user. FIG. 1A depicts an example of such a system 100, where client terminals 12-1 through 12-4 may upload and download documents to/from a document storage part of the document management system 15, via the network 11.

There is a drawback, however, in that the search results of a conventional document management system are not filtered based on the extent of data accessible by the specific user. That is, the search results provided to the user include a list of all of the documents retrieved based on the search key terms, even though some of these documents may not be authorized for access by the user.

FIG. 1B depicts an example of a user interface of a conventional document management system that displays search results. The search results include a list of all of the retrieved documents from a search based on key terms entered by the user. If the user selects the document “FY09Q3.Draft.doc” from the search results, for example, and in fact this document is not accessible by the user because the user is not authorized to view the document, then the user will be confronted with an error message as seen in FIG. 1C. Thus, great inconvenience is caused to the user, since the search results are not filtered based on the extent of data accessible by the user.

There exists a need for an improved document management system which is not as difficult and time-consuming to use.

### SUMMARY

This disclosure provides user interface tools (in the form of systems, apparatuses, methodologies, computer program products, etc.) for managing and accessing documents or files).

In an aspect of this disclosure, for each of plural particular users, user access information of the particular user is maintained and includes data access information indicating an extent of data that is accessible by the particular user from a document database through the document management application, and search results provided to the particular user for a search requested by the particular user include only documents and document data that are within the extent of the data accessible by the specific user in the document database, as indicated by the data access information included in the user access information. The search results provided to the specific user do not include documents or document data that are not within the extent of the data accessible by the specific user.

In an exemplary embodiment, a search interface of an application user interface apparatus communicates the user access information along with one or more key terms (specified by an application user) through a network to the document management application, and the document management application determines based on the user access information and data access information for the application user, the extent of the data accessible by the application user in the document database, and limits the search results returned by document management application through the network to the application user interface apparatus to only the documents or document data that are within the extent of the data accessible by the application user and does not return the documents or document data that are not within the extent of the data accessible by the specific user.

In another aspect, the search user interface processes search results received from a document management application, in accordance with a determination of the extent of data accessible by a specific user based on business relevancy information of the specific user, to generate processed search results that do not include documents or document data that are not within the extent of the data accessible by the specific user.

In another exemplary embodiment, the application user interface apparatus communicates a search command and the key terms to the document management application, and results, received by the application user interface apparatus through the network from the document management application, of the search performed by the document management application are filtered, based on the user access information, to obtain the search results that do not include documents or document data that are not within the extent of the data accessible by the application user.

In another aspect, the user access information maintained for a specific user includes document parameters information indicating specified document parameters available to the application user for specifying a search to be performed, and such specified document parameters does not include at least one document parameter maintained for documents in the document database by the document management application. The operations user interface provided to the application user for specifying the search to be performed allows for the application user to select from the specified document parameters, and not from other document parameters maintained for documents in the document database by the document management application.

In another aspect, the specified document parameters are selected by a specific user, as a subset, from all of the document parameters maintained for documents in a document database by a document management application, and the subset of selected document parameters are registered as the document parameters information for the specific user.

### BRIEF DESCRIPTION OF THE DRAWINGS

The aforementioned and other features, aspects and advantages can be more readily understood from the following detailed description with reference to the accompanying drawings wherein:

FIG. 1A shows a block diagram of a conventional system;

FIGS. 1B and 1C show user interfaces of a conventional system;

FIG. 2 shows a block diagram of a system, according to an exemplary embodiment of this disclosure;

FIG. 3A shows an example of user access information, while FIG. 3B explains aspects of the data access information included in the user access information of FIG. 3A;

FIG. 4A shows an example of a screen of a login user interface;

FIG. 4B shows an example of a screen of a search user interface;

FIG. 5 shows an example of a workflow on a document access apparatus (or application user interface apparatus) side;

FIG. 6 shows another example of user access information;

FIG. 7 shows another example of a screen of a search user interface;

FIG. 8 shows a block diagram of a system, according to another exemplary embodiment of this disclosure;

FIGS. 9A and 9B show an example of a more detailed workflow on a document access apparatus (or application user interface apparatus) side;

FIG. 10 shows an example of a workflow on a document management apparatus side;

FIG. 11 shows a block diagram of an exemplary configuration of a document access apparatus (or application user interface apparatus);

FIG. 12 shows a block diagram of an exemplary configuration of a client terminal; and

FIG. 13 shows a schematic view of an example of a data flow in an exemplary embodiment.

### DETAILED DESCRIPTION

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. In addition, a detailed description of known functions and configurations will be omitted when it may obscure the subject matter of the present invention.

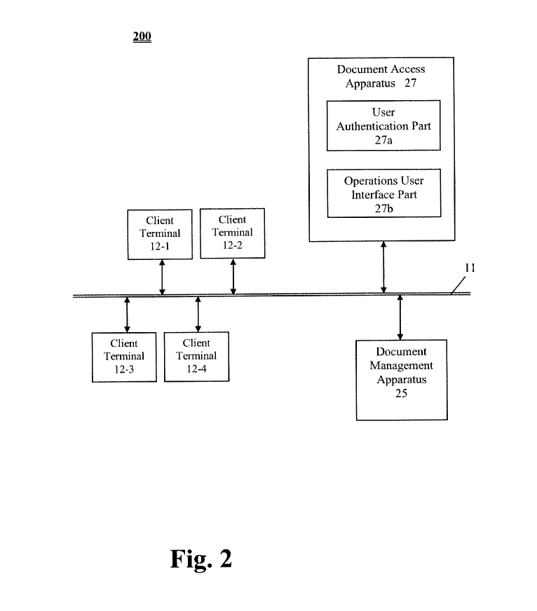

Referring now to the drawings, wherein like reference numerals designate identical or corresponding parts throughout the several views, FIG. 2 shows schematically a system 200 for streamlining access in a document management system, according to an exemplary embodiment of this disclosure.

System 200 includes a plurality of client terminals 12-1 through 12-4, a document management apparatus 25, and a document access apparatus (or also referenced herein as “application user interface apparatus”) 27, all of which are interconnected by a network 11.

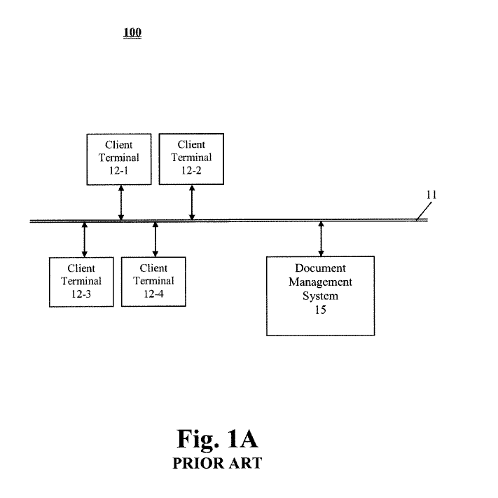

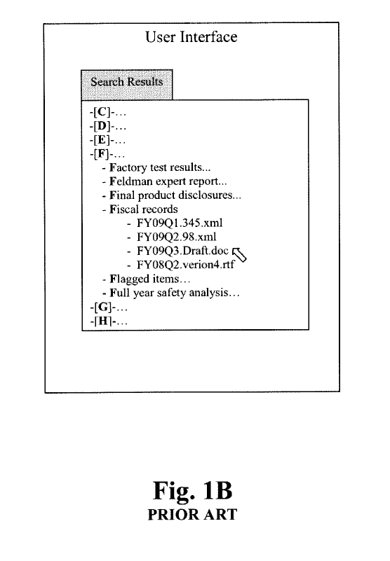

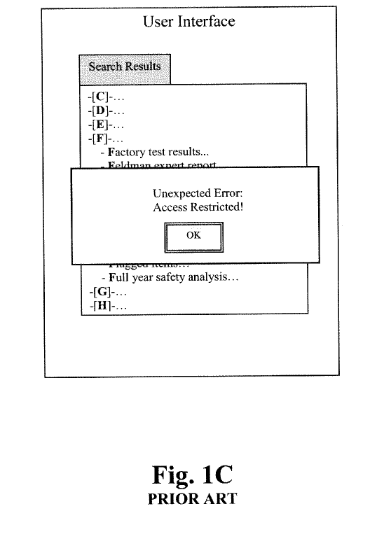

The document management apparatus 25 may be substantially similar to the document management system 15 depicted in FIG. 1, and may include a plurality of application functionalities. The plurality of client terminals 12-1 through 12-4 may be substantially similar to those depicted in FIG. 1. In particular, the client terminals 12-1 through 12-4 are configured with software allowing the client terminals to communicate through the network 11 with at least the document access apparatus 27 and preferably also the document management apparatus 25. In particular, the client terminals 12-1 through 12-4 may transmit data to, and receive data from, the document access apparatus 27.

Document access apparatus 27 includes a user authentication part 27a, and an operations user interface part 27b.

The user authentication part 27a is configured to maintain, for each particular one of a plurality of users, user access information corresponding to the particular user. The user access information includes data access information that indicates an extent of data that is accessible by the particular user, from a document database through the document management apparatus 25.

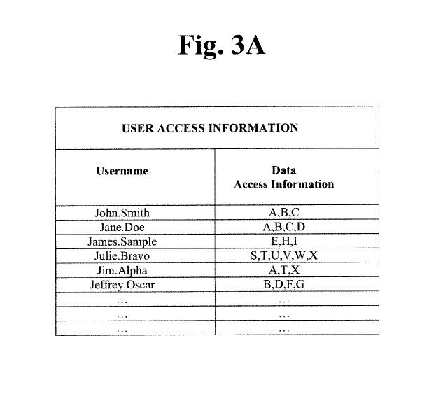

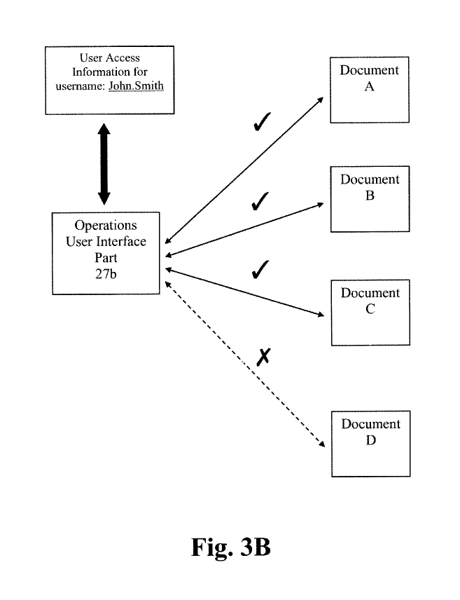

FIG. 3A depicts an example of user access information. In particular, the user access information identifies, by username, a plurality of registered users of the document management apparatus 25. The user access information also includes the corresponding data access information identifying documents or document data that the user is authorized to access. For example, the registered user John.Smith is permitted to access the documents ‘A’, ‘B’ and ‘C’, the registered user Jane.Doe is permitted to access the documents ‘A’, ‘B’, ‘C’ and ‘D’, the registered user Jeffrey.Oscar is permitted to access the documents ‘B’, ‘D’, ‘F’ and ‘G’, and so on. Thus, the user access information includes data access information that indicates an extent of data that is accessible by the particular user from a document database of the document management apparatus 25.

It should be apparent that the user access information is not limited to that shown in FIG. 3A, which merely presents an example. While this discussion of the data access information refers to documents and document data, the data access information can of course identify other types of information that the specific user is authorized to access, such as the general databases to which the specific user has access privileges, or application functionalities of the document management system to which the specific user has access privileges. The access control data may be set by a systems administrator or a manager, for example.

In addition to maintaining, for each particular one of a plurality of users, user access information corresponding to the particular user, the user authentication part 27a of the document access apparatus 27 is also configured to receive and utilize user information from login of a specific user to perform user authentication of the specific user.

The user information may include a username and user authentication data, such as a password. However, the user information may include any information that may be used to login, identify or authenticate a user of a user terminal that may be in communication with a document management apparatus. For example, the user information can include a plurality of names, passwords, screen names, email addresses, telephone numbers, facsimile numbers, etc. The user information may include biometric information (such as fingerprints, palm prints, voice or speech, retinas or irises, facial expressions or features, signature, etc).

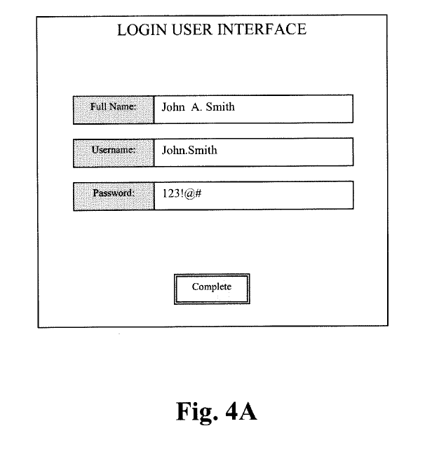

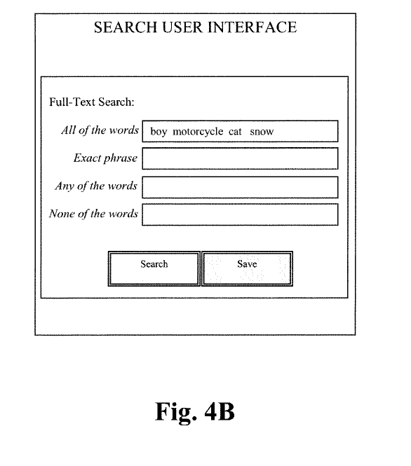

The user authentication part 27a may supply a login user interface through the network to a user terminal (such as one of the plurality of terminals 12-1 through 12-4) or a multi-function device, for a specific user to login to the document access apparatus 27. An example of a login user interface, provided by the user authentication part 27a for a specific user to login to the document access apparatus 27, is depicted in FIG. 4A. This screen of the login user interface may be used to login a user “John Smith” by, for example, allowing the user to enter in user information such as the user's full name, username, and password, as seen in FIG. 4A. This user information is received and utilized by the user authentication part 27a to perform user authentication for the specific user.

After the user authentication part 27a utilizes the user information of the specific user to authenticate the specific user, the user authentication part 27a also utilizes the user information of the specific user to retrieve the user access information maintained for the specific user. For example, the user authentication part 27a may utilize a username of a specific user provided during login of the specific user (via the login user interface, for example, as depicted in FIG. 4A), to retrieve the user access information, as depicted in FIG. 3A.

Returning to FIG. 2, the operations user interface part 27b of the document access apparatus 27 is configured to receive one or more key terms entered by the specific user for a search, as well as a search instruction requesting that a search of the documents and document data of the document management apparatus 25 be performed based on the key terms.

The operations user interface part 27b may supply a search user interface through the network 11 to a user terminal (such as one of the plurality of terminals 12-1 through 12-4) or a multi-function device, for the specific user to supply the one or more key terms and the search instruction requesting that a search be performed based on the key terms. An example of such a search user interface is depicted in FIG. 4A, and it may be seen that the user is searching for documents and document data of the document management apparatus 25 that includes all of the words ‘boy’, ‘motorcycle’, ‘cat’, and ‘snow’. Thus, the key terms in this case are ‘boy’ AND ‘motorcycle’ AND ‘cat’ AND ‘snow’.

The operations user interface part 27b includes a search interface configured to communicate with the document management apparatus 25, and to transmit a search command and the one or more key terms to the document management apparatus 25, so that the document management apparatus 25 can perform the search based on the one or more key terms. The search interface is also configured to receive search results of the search performed by the document management apparatus 25, based on the one or more key terms, from the document management apparatus 25.

Further, the search interface of the operations user interface part 27b processes the results received from the document management apparatus 25, based on the user access information of the specific user that requested the search, to generate processed search results that do not include documents or document data that are not within the extent of the data accessible by the specific user. The search interface may accomplish this by removing any search result that does not correspond to the defined extent of data that is accessible by the particular user, as indicated by the data access information for the particular user.

With reference to the user access information of FIG. 3A, for example, it may be seen that the registered user John.Smith is permitted to access the documents ‘A’, ‘B’ and ‘C’, based on the data access information for the username John.Smith. If the search results for a search requested by the user John.Smith include only the documents A and/or B and/or C, then the search interface does not need to process the search results. However, if the search results for a search requested by the user John.Smith include documents other than A or B or C, such as the document D, then the search interface processes the search results and removes any documents other than A or B or C, such as the document D, to generate processed search results. As a result, the user is not able to access document data that is not within the extent of data accessible by the specific user, as depicted in FIG. 3B. Thus, the search interface filters, based on the user access information, the results received from the document management apparatus 25 to obtain the search results that do not include documents or document data that are not within the extent of the data accessible by the specific user.

The operations user interface 27b part provides, to the specific user, the processed search results that include only documents or document data that are within the extent of the data accessible by the specific user in the document database, as indicated by the data access information included in the user access information retrieved by the user authentication part 27a. A search user interface, which as described above may be supplied by the operations user interface part 27b to the user terminal or multi-function device for the specific user to supply the one or more key terms, may also be used to transmit the processed search results through the network to the user terminal or multi-function device, so that the processed search results are provided for the specific user to view.

Thus, the search results provided to the specific user do not include documents or document data that are not within the extent of the data accessible by the specific user.

According to this exemplary embodiment of the present invention, there is provided the tools for the efficient exchange and management of documents and files, and for streamlining access in a document management system. Whereas conventional techniques typically provide search results to a user that include documents or document data that the specific user is not authorized to access anyway, the search results of the present disclosure are processed based on user access information to generate processed search results that do not include documents or document data that are not within the extent of the data accessible by the specific user. Hence, the operational convenience to users of the present invention is greatly increased.

According to another exemplary embodiment of this disclosure, the operations user interface part 27a of the document access apparatus 27 may transmit the user access information to the document management apparatus 25, so the processing of the search results may be performed at the document management apparatus 25 side. The search interface of the operations user interface part 27a communicates the user access information including the data access information, as depicted in FIG. 3A, along with the one or more key terms, to the document management apparatus 25. Thereafter, the document management apparatus 25 performs the search based on the key terms, and then processes the search results, based on the user access information received from the document access apparatus 27, to generate processed search results that do not include documents or document data that are not within the extent of the data accessible by the specific user. Thereafter, the document access apparatus 27 receives through the network from the document management apparatus 25, the search results that include only the documents or document data that are within the extent of the data accessible by the specific user. That is, the returned search results do not include the documents or document data that are not within the extent of the data accessible by the specific user. In this case, the document access apparatus 27 does not need to process the returned search results.

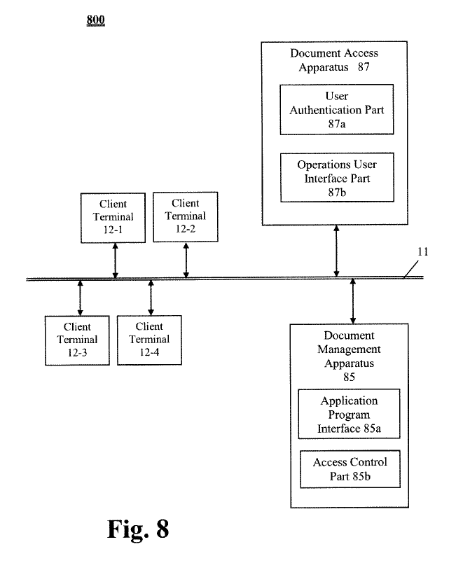

As an alternative to performing the search based on the key terms, and then processing the search results based on the user access information, the document management apparatus 25 may instead utilize the user access information to simply limit the extent of the search only to the appropriate document data that is within the extent of data accessible by the specific user, as will be described later with reference to the system 800 in FIG. 8.

The document access apparatus 27 may be embodied as a server that is distinct from the document management apparatus 25. In this way, the document access apparatus 27 may correspond to a first server, and the document management apparatus 25 may correspond to a second server separate and distinct from the first server. Hence, while conventional document management systems typically have an integrated user interface, such that any modification of the user interface would require taking the document management system offline, the document access apparatus 27 of this disclosure is configured for modification without taking the document management apparatus 25 offline.

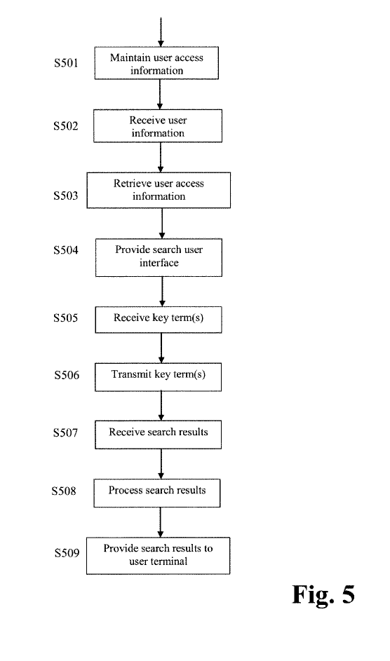

Turning now to FIG. 5, there is shown an example of a workflow on a document access apparatus side, such as the document access apparatus 27 in FIG. 2.

Firstly, in S501 user access information is maintained by a document access apparatus for a plurality of specific users. The user access information for each one of the plurality of specific users includes data access information indicating an extent of data accessible by the specific user in a document database maintained by a document management system. An example of user access information is depicted in FIG. 3A.

In S502, user information is transmitted from a user terminal to the document access apparatus, during login of a user into the document access apparatus via a login user interface, for example. The document access apparatus may utilize the user information from login of a specific user to perform user authentication of the specific user. The document access apparatus may also utilize the received user information to retrieve the user access information maintained for the specific user (S503). The user access information includes data access information indicating an extent of data that is accessible by the particular user, as depicted in FIG. 3A, for example.

In S504, a search user interface is provided by the document access apparatus to the specific user. The search user interface is provided for the specific user to supply one or more key terms for a search based on the one or more key terms.

In S505, the one or more key terms supplied by the user via he search user interface are transmitted back to the document access apparatus.

As a result, the document access apparatus transmits a search command and the one or more key terms to the document management apparatus, for the document management apparatus to perform the search based on the one or more key terms (506). Note that the document access apparatus may also transmit user access information to the document management apparatus.

Then, in S507, the document access apparatus receives the search results from the document management apparatus. In S508, the document access apparatus processes the search results received from the document management apparatus, based on the user access information of the specific user that requested the search, to generate processed search results that do not include documents or document data that are not within the extent of the data accessible by the specific user. Thus, the search results include only documents or document data that are within the extent of the data accessible by the specific user in the document database, as indicated by the data access information included in the user access information.

Finally, in S507, the processed search results are transmitted from the document access apparatus to the specific user at the user terminal, wherein the search results include only documents or document data that are within the extent of the data accessible by the application user in the document database, as indicated by the user access information of the specific user, and wherein the search results provided to the specific user do not include documents or document data that are not within the extent of the data accessible by the specific user.

Alternatively, the processing of the search results based on the user access information may be performed on the document management apparatus side. In such a case, the document access apparatus need not process the search results, and S508 may be omitted.

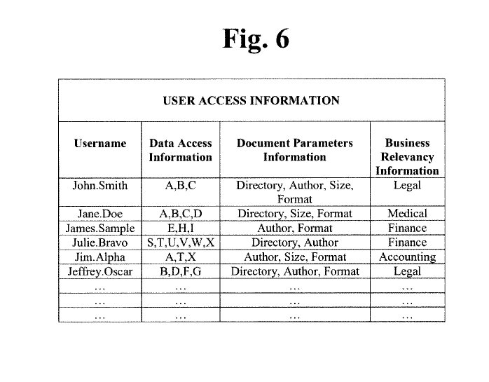

According to another aspect of this disclosure, the user access information maintained by the user authentication part 27a for the specific user further includes document parameters information indicating specified document parameters available to the specific user for specifying a search to be performed. FIG. 6 depicts user access information, similar to the user access information depicted in FIG. 3A. It will be seen that the user access information of FIG. 6 also includes the document parameters information indicating specified document parameters available to the specific user for specifying a search to be performed.

Document parameters include one of many parameters pertaining to a document or document data. Examples of document parameters maintained for documents in the document database by the document management apparatus 25 include document name, size, author, creation date, modification date, file format, directory location, classification, and so forth.

Thus, it may be seen in FIG. 6 that the document parameters information for username John.Smith indicates that the specified document parameters ‘Directory’, ‘Author’, ‘Size’ and ‘Format’ are available to the specific user for specifying a search to be performed. It will be seen that for some users such as Jane.Doe, the specified document parameters do not include at least one document parameter (e.g. ‘Author’) maintained for documents in the document database by the document management apparatus 25.

The search user interface part, provided to the specific user by the operations user interface part 27a for specifying the search, also allows the specific user to select from the document parameters specified in the document parameters information for the specific user (and not from other document parameters not specified by the document parameters information for the specific user).

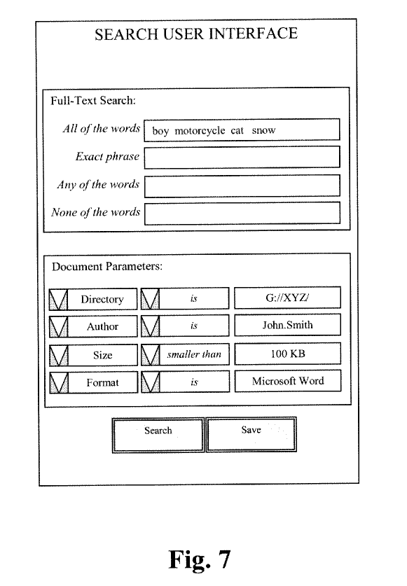

With reference to FIG. 7, there is depicted a search user interface for specifying key terms, similar to the search user interface depicted in FIG. 4B. It may be seen that the search user interface allows for the specific user to select from document parameters such as ‘Directory’, ‘Author’, ‘Size’ and ‘Format’ in order to narrow the search. The document parameters may be selected using pull-down option menus, for example. The user can edit the fields such as ‘G://XYZ/’ and ‘100 KB’ as necessary, or remove one of the document parameters entirely.

It should be understood that the document parameters available to a specific user in the search user interface only include the document parameters specified in the document parameters information of the specific user (and not other document parameters not specified by the document parameters information for the specific user). For example, the search user interface depicted in FIG. 7 may correspond to a search user interface for user John.Smith, since the document parameters information in FIG. 6 for this user indicates that the specified document parameters ‘Directory’, ‘Author’, ‘Size’ and ‘Format’ are available to the specific user for specifying a search to be performed. On the other hand, a search user interface for the user ‘Jane.Doe’ would not include the ‘Author’ document parameter (i.e. would not allow the user to select this parameter from a pulldown menu).

Thus, the specified document parameters are selected by the specific user as a subset of all of the document parameters maintained for documents in the document database by the document management apparatus, and the subset of selected document parameters are registered as the document parameters information for the specific user. The document parameters information may be determined by a systems administrator or a manager, for example.

According to another aspect of this disclosure, the user access information may also include business relevancy information indicating a specific business relevancy field pertinent to the registered user. FIG. 6 depicts user access information, similar to the user access information depicted in FIG. 3A. It will be seen that the user access information of FIG. 6 also includes business relevancy information, which indicates that a “Legal” business relevancy field is pertinent for username John.Smith, a “Medical” business relevancy field is pertinent for the username Jane.Doe, and so on.

Further, the search interface of the operations user interface part 27a may determine, based at least in part on the business relevancy information of the specific user, the extent of data accessible by the specific user in the document database. For example, if the business relevancy information for John.Smith indicates that the “Legal” business relevancy field is pertinent for this specific user, then the search interface may determine that the extent of data accessible by the user John.Smith does not include document data related to medicine or documents classified as relevant to the “Medical” business relevancy field. Conversely, if the business relevancy information for Jane.Doe indicates that the “Medical” business relevancy field is pertinent for this specific user, then the search interface may determine that the extent of data accessible by the user Jane.Doe does not include document data related to accounting or classified as relevant to the “Accounting” business relevancy field.

The search user interface of the operations user interface part 27a may process the search results received from the document management apparatus 25, in accordance with the determination described above—that is, the determination of the extent of data accessible by the specific user based on the business relevancy information of the specific user. The search user interface may thereby generate processed search results that do not include documents or document data that are not within the extent of the data accessible by the specific user. For instance, continuing with the example described above, any search results based on a search requested by the user John.Smith that pertain to “Medical” business relevancy field information, may be processed out of the search results.

Turning now to FIG. 8, there is shown schematically a system 800 for streamlining access in a document management system, according to another exemplary embodiment of this disclosure.

System 800 includes a plurality of client terminals 12-1 through 12-4, a document management apparatus 85, and a document access apparatus 87.

The plurality of client terminals 12-1 through 12-4 may be substantially similar to those of FIG. 2.

The document management apparatus 85 may be substantially similar to the document management apparatus 25 of FIG. 2. However, the document management apparatus 85 further includes an application program interface 85a and an access control part 85b. The application program interface 85a is configured to specify a format of communication with the document management apparatus 85.

The application program interface 85a is similar to the application programming interfaces (APIs) known in the art, which are interfaces often implemented in software that specify the commands and instructions that an application or device may be configured to accept. In this way, the application program interface 85a of the document management apparatus 85 may include specifications for routines and protocols that are to be used when communicating with the document management apparatus 85 or requesting the application functionalities of the document management apparatus (such as uploading, accessing and downloading documents).

The document access apparatus 87 is similar to the document access apparatus 27 of FIG. 2. Further, the document access apparatus 87 is configured to communicate with the application program interface 85a of the document management apparatus 85, when user input is received at the operations user interface part 87a of the document access apparatus 87. The user input through the operations user interface may be, for example, a request to perform a search based on search key terms. The document access apparatus is also configured to send a command, corresponding to the user input and acceptable to the document management apparatus 85, to the document management apparatus to access one or more corresponding application functionalities of the document management apparatus.

Specifically, when the document access apparatus 87 communicates with the application program interface 85a of the document management apparatus 85, the document access apparatus determines a set of possible instructions that the document management apparatus is able to accept. Based on this set of possible instructions, the document access apparatus prepares a command or set of commands corresponding to the user input that the document management apparatus is able to accept, and transmits this command to the document management apparatus.

For example, if the user input is a request to download all instances of a certain type of document (such as a spreadsheet or a presentation document) that is known to be associated with a certain file format (such as .xml or .ppt), then the document access apparatus communicates with the application program interface 85a of the document management apparatus 85, in order to determine the protocols for requesting documents of a specific file format from the document management apparatus. The document access apparatus can then prepare and transmit the appropriate command that is acceptable to the document management apparatus.

The document access apparatus is also configured to receive at least one document or other piece of information such as search results from the application program interface 85a of the document management apparatus 85, in response to the command transmitted from the document access apparatus to the document management apparatus 85. Following this, the operations user interface provides the document or other information for access by the specific user.

Thus, the document access apparatus 87 of this disclosure has the capacity to receive user input from one of a plurality of user interfaces, and send a command corresponding to the user input to a document management apparatus to access an application functionality of the document management apparatus, where the command is prepared so as to be acceptable to the document management apparatus. Since the document access apparatus 87 prepares the command by communicating with an application program interface 85a of a document management apparatus 85, the document access apparatus becomes highly flexible and has the capacity to communicate with a plurality of different document management apparatuses.

The access control part 85b of the document management apparatus is configured to maintain, for each registered user, access control data indicating portions of documents and document data in a document database that the registered user is authorized to access.

Furthermore, the access control part 85b of the document management apparatus 85 receives the user access information of the application user and determines the extent of data accessible by the application user in the document database, and limits the search based on the one or more key terms to the extent of the data accessible by the specific user, to return search results that include only documents or document data that are within the extent of the data accessible by the specific user in the document database. For example, if the data access information included in the user access information for a specific user indicates that the user is not permitted to access the documents ‘E’ through ‘Z’, then the document management apparatus will not include these documents in the search, and will only search other document data. The search results returned by the document management apparatus 85 through the network to the document access apparatus 27 do not include documents or document data that are not within the extent of the data accessible by the specific user. The search user interface of the document access apparatus 87 displays the search results returned by the document management apparatus 85 through the network to the document access apparatus 87.

The access control part 85b of the document management apparatus 85 may also receive user access information that includes business relevancy information of the application user, and the document management apparatus 85 may determine, based at least in part on the business relevancy information of the application user, the extent of data accessible by the application user in the document database. The document management apparatus may then limit the search based on the one or more key terms to the extent of the data accessible by the specific user, as determined at least in part by the business relevancy information. Alternatively, the document management apparatus 85 may process the search results received from the document management application, in accordance with the determination of the extent of data accessible by the specific user based on the business relevancy information of the specific user, to generate processed search results that do not include documents or document data that are not within the extent of the data accessible by the specific user

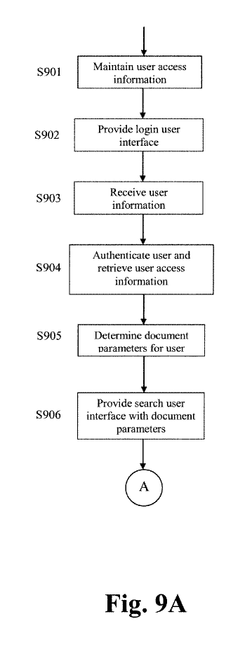

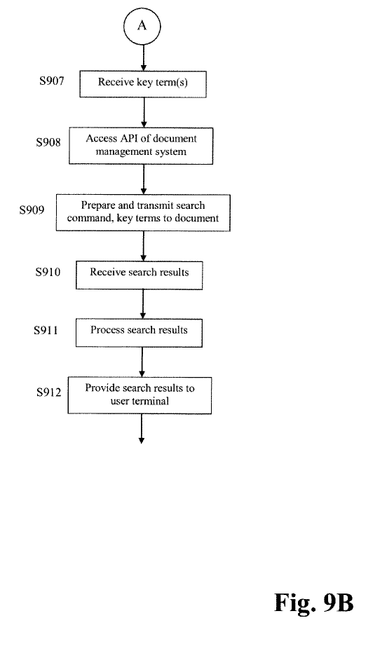

In FIGS. 9A and 9B, a flow chart is shown illustrating an example of a more detailed workflow on a document access apparatus side such as the document access apparatus 87 in FIG. 8).

Firstly, in S901 user access information is maintained by a document access apparatus for a plurality of specific users. The user access information for each one of the plurality of specific users includes data access information indicating an extent of data accessible by the specific user in a document database maintained by a document management system. An example of user access information is depicted in FIG. 6.

Then, a login user interface is provided by a document access apparatus to a specific user at a terminal (S902). The login user interface is provided for a specific user to login, and to enter user information for transfer to a document access apparatus.

In S903, the user information is transmitted to the document access apparatus. The document access apparatus utilizes the user information from login of a specific user to perform user authentication of the specific user and retrieve the user access information maintained for the specific user (S904). The user access information includes data access information indicating an extent of data that is accessible by the particular user, from a document database through the document management application. An example of user access information is depicted in FIG. 6.

In S905, the document access apparatus determines document parameters for a user, based on document parameters information included in the user access information retrieved in S904.

In S906, a search user interface is provided by the document access apparatus to the specific user. The search user interface is provided for the specific user to supply one or more key terms for a search based on the one or more key terms, and may include the document parameters determined in S905.

In S907, the one or more key terms supplied by the user are transmitted back to the document access apparatus. In S908, the document access apparatus accesses the application program interface (API) of the document management apparatus in order to determine the set of possible instructions that the document management apparatus is able to accept. In S909, the document access apparatus determines the appropriate command to be issued to the document management apparatus, based on the user instructions input in S907 and the set of possible instructions determined in S908. In this way, the document access apparatus may conform the search command to a format specified by the application program interface of the document management apparatus. The document access apparatus also transmits the command to the document management apparatus in S909.

Then, in S910, the document access apparatus receives the search results from the document management apparatus.

In S911, the document access apparatus processes the search results received from the document management apparatus, based on the user access information of the specific user that requested the search, to generate processed search results that do not include documents or document data that are not within the extent of the data accessible by the specific user. Thus, the search results include only documents or document data that are within the extent of the data accessible by the specific user in the document database, as indicated by the data access information included in the user access information.

Finally, in S912, the processed search results are transmitted from the document access apparatus to the specific user at the user terminal, wherein the search results include only documents or document data that are within the extent of the data accessible by the application user in the document database, as indicated by the user access information of the specific user, and wherein the search results provided to the specific user do not include documents or document data that are not within the extent of the data accessible by the specific user.

Alternatively, the processing of the search results based on the user access information may be performed on the document management apparatus side. In such a case, the document access apparatus need not process the search results, and S911 may be omitted.

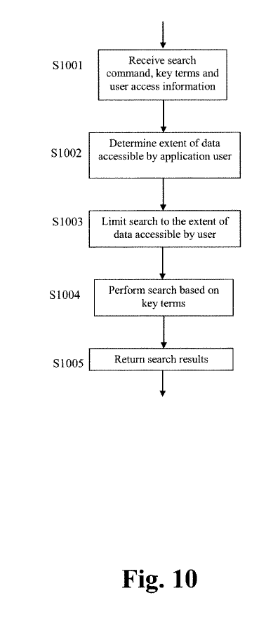

In FIG. 10, a flow chart is shown illustrating an example of a workflow on a document management apparatus side such as the document management apparatus 85 in FIG. 8).

In S1001, the document management apparatus receives key terms and a search command to perform a search of document data based on the key terms. The document management apparatus also receives user access information, such as depicted in FIG. 6.

In S1002, the document management apparatus determines the extent of data accessible by an application user, based on the user access information received in S1001. In particular, the document management apparatus may make the determination based on data access information and business relevancy information included in the user access information.

Then in S1003, the document management apparatus limits the scope of a search to the extent of data accessible by the user, based on the determination made in S1002. The search based on the key terms is performed in S1004, and the results are returned to the user in S1005.

While the examples shown in FIG. 2 and FIG. 8 include one document management apparatus, one document access apparatus and four client terminals 12-1 through 12-4, it should be appreciated that such numbers of systems, servers, apparatuses and terminals are arbitrary and are selected as an example in order to facilrtate discussion, and that the subject matter of this disclosure can be implemented in a system including one or more systems, servers, apparatuses and terminals. Further, it is noted that a document access apparatus and terminal can be included in one integrated device (or of course can be separate devices).

Other devices, such as scanners, printers and multi-function devices (MFDs) may also be connected to the network 11, as is well known in the art.

Each of the client terminals 12-1 through 12-4 can be any computing device, including but not limited to a personal, notebook or workstation computer, a kiosk, a PDA (personal digital assistant), a MFD (multi-function device), a server, a mobile phone or handset, another information terminal, etc., that can communicate through the network 11 with other devices.

While four client terminals 12-1 through 12-4 are depicted in each of FIG. 2 and FIG. 8, it should be understood that system 200 and 800 can include any number of client terminals (which can have similar or different configurations) connected to the network 11.

The document access apparatus 27 (and 87) can be configured in software or hosted on any computing device, including but not limited to a personal, notebook or workstation computer, a kiosk, a PDA (personal digital assistant), a MFD, a server, a mobile phone or handset, another information terminal, etc., that can communicate through the network 11 with other devices.

The document access apparatus 27 (and 87) of this disclosure may be realized by a computer program product including a computer-usable, non-transient medium (such as a disk storage apparatus) having instructions tangibly embodied therein that are executed by a computer.

Thus, it should be understood that document access apparatus 27 (and 87) may be executed on a computer. While document access apparatus 27 (and 87) are shown as being external to the client terminals 12-1 through 12-4, the document access apparatus 27 (and 87) may in fact be executed on one of the client terminals 12-1 through 12-4.

The document management apparatus may include a data store that can comprise one or more structural or functional parts that have or support a storage function. For example, the data store can be, or can be a component of, a source of electronic data, such as a document access apparatus, a backend server connected to a document access apparatus, an e-mail server, a file server, a multi-function peripheral device (MFP or MFD), a voice data server, an application server, a computer, a network apparatus, a terminal etc. It should be appreciated that the term “electronic document” or “electronic data”, as used herein, in its broadest sense, can comprise any data that a user may wish to access, retrieve, review, etc.

The network 11 can include one or more of a secure intranet or extranet local area network, a wide area network, any type of network that allows secure access, etc., or a combination thereof. Further, other secure communications links (such as a virtual private network, a wireless link, etc.) may be used as well in the network 11. In addition, the network 1 preferably uses TCP/IP (Transmission Control Protocol/Internet Protocol), but other protocols can also be used. How devices can connect to and communicate over the network 11 is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

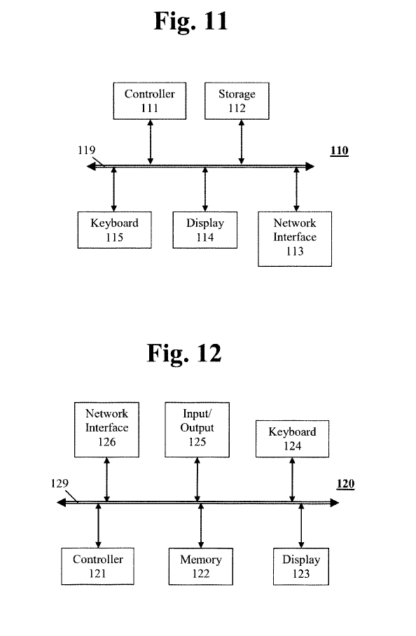

FIG. 11 shows an exemplary constitution of a document access apparatus 110 as a computer, for example, that can be configured through software to provide the document access apparatus 27 of FIG. 2 (or document access apparatus 87 of FIG. 8). As shown in FIG. 11, the document access apparatus 110 includes a controller (or central processing unit) 111 that communicates with a number of other components, including memory or storage part 112, network interface 113, display 114 and keyboard 115, by way of a system bus 119.

The document access apparatus 110 may be a special-purpose device (such as including one or more application specific integrated circuits or an appropriate network of conventional component circuits) or it may be software-configured on a conventional personal computer or computer workstation with sufficient memory, processing and communication capabilities to operate as a terminal and/or server, as will be appreciated to those skilled in the relevant arts.

In document access apparatus 110, the controller 111 executes program code instructions that control conferencing apparatus operations. The controller 111, memory/storage 112, network interface 113, display 114 and keyboard 115 are conventional, and therefore in order to avoid occluding the inventive aspects of this disclosure, such conventional aspects will not be discussed in detail herein.

The document access apparatus 110 includes the network interface 113 for communications through a network, such as communications through the network 11 with the client terminals 12-1 through 12-4 and document management apparatus 25 in FIG. 2. However, it should be appreciated that the subject matter of this disclosure is not limited to such configuration. For example, the document access apparatus may communicate with the client terminals 12-1 through 12-4 and document management apparatus 25 through direct connections and/or through a network to which some components are not connected. As another example, the document access apparatus need not be provided by a server that services terminals, but rather may communicate with the terminals on a peer basis, or in another fashion.

As mentioned above, document access apparatus 27 and 87) are not limited to a server or computer, but can be manifested in any of various devices that can be configured to communicate over a network and/or the Internet.

Note that one or more of the user interfaces (such as the registration user interface or the operations user interface) may be provided as web services through the network to the client terminal.

An example of a configuration of one of the plurality of client terminals 12-1 through 12-4 (for example, as a computer) is shown schematically in FIG. 12. In FIG. 12, computer 120 includes a controller (or central processing unit) 121 that communicates with a number of other components, including memory 122, display 123, keyboard (and/or keypad) 124, other input/output (such as mouse, touchpad, stylus, microphone and/or speaker with voice/speech interface and/or recognition software, etc.) 125, and network interface 126, by way of internal bus 129.

The memory 122 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 126 provides a connection (for example, by way of an Ethernet connection or other network connection which supports any desired network protocol such as, but not limited to TCP/IP, IPX, IPX/SPX, or NetBEUI) to network 11.

A user interface is provided and is configured through software natively or received through a network connection, to allow the user to access electronic data or content on the client terminal and/or via the network, interact with network-connected devices and services (such as the document management apparatus 25), enjoy other software-driven functionalities, etc. For example, a browser (such as Internet Explorer™, Netscape Navigator™, a proprietary browser, etc.) may be provided on the client terminal so that a user of the client terminal can use browsing operations to communicate with the document management apparatus 25, and access other data or content.

Additional aspects or components of the computer 120 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

As mentioned above, each of the client terminals 12-1 through 12-4 is not limited to a personal computer, but can be manifested in a form of any of various devices that can be configured to communicate over a network and/or the Internet.

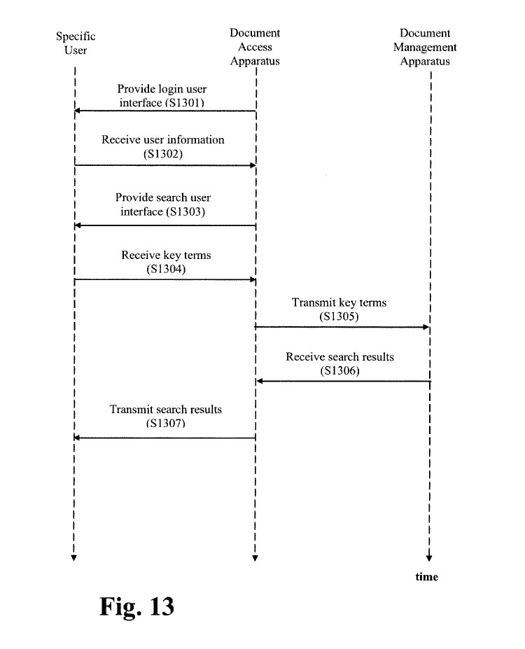

Turning now to FIG. 13, a schematic view of an example of data flow in an exemplary embodiment is presented.

Firstly, a login user interface is provided by a document access apparatus to a specific user at a terminal (S1301). The login user interface is provided for a specific user to login, and to enter user information for transfer to a document access apparatus. An example of user information is depicted in FIG. 3A.

In S1302, the user information is transmitted to the document access apparatus. The document access apparatus utilizes the user information from login of a specific user to perform user authentication of the specific user and retrieve user access information maintained for the specific user. The user access information includes data access information indicating an extent of data that is accessible by the particular user, from a document database through the document management application. An example of user access information is depicted in FIG. 3A.

In S1303, a search user interface is provided by the document access apparatus to the specific user. The search user interface is provided for the specific user to supply one or more key terms for a search based on the one or more key terms.

In S1304, the one or more key terms supplied by the user are transmitted back to the document access apparatus.

The document access apparatus then transmits the one or more key terms to the document management apparatus, to perform the search based on the one or more key terms (1305). The document access apparatus may also transmit user access information to the document management apparatus.

Then, in S1306, the document access apparatus receives the search results from the document management apparatus. The document access apparatus may process the search results to generate processed search results that include only documents or document data that are within the extent of the data accessible by the specific user in the document database, as indicated by the data access information included in the user access information,

Finally, in S1307, the processed search results are transmitted from the document access apparatus to the specific user at the user terminal, wherein the search results provided to the specific user do not include documents or document data that are not within the extent of the data accessible by the specific user.

The above-mentioned specific embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

What is claimed is:

1. A system for providing document management services to a terminal, said system comprising:
a document management apparatus configured to execute a document management application that includes a plurality of application functionalities, the application functionalities including a document registration function to register a specified document in a document database, and a search function to search the document database based on specified terms; and
an application user interface apparatus configured to communicate through a network with the document management application, the application user interface apparatus including:
a user authentication part configured to maintain, for each specific one of plural users, user access information corresponding to the specific user, and configured to receive and utilize user information from login of an application user to perform user authentication of the application user; and
an operations user interface part configured to provide a search user interface, receive one or more key terms entered by the application user through the search user interface for a search, communicate a search command, the one or more key terms and the user access information of the application user through the network to the document management apparatus, and provide, via the search user interface, search results returned by the document management application through the network,
wherein the search results provided to the application user through the search user interface include only documents or document data that are within the extent of the data accessible by the specific user in the document database, and do not include documents or document data that are not within the extent of the data accessible by the specific user.

2. The system of claim 1, wherein the document management apparatus further includes an access control part configured to control, for each of a plurality of particular users, an extent of data that is accessible by the particular user, from the document database.

3. The system of claim 2, wherein the access control part maintains data access information for the particular user, the data access information indicating the extent of data that is accessible by the particular user, from the document database.

4. The system of claim 2,
wherein the access control part of the document management apparatus receives the user access information of the application user, determines the extent of data accessible by the application user in the document database, limits the search based on the one or more key terms to the extent of the data accessible by the specific user, and returns the search results that include only documents or document data that are within the extent of the data accessible by the specific user in the document database.

5. The system of claim 1, wherein
the user access information maintained by the user authentication part of the application user interface apparatus includes business relevancy information indicating a specific business relevancy field pertinent to the specific user, and
the access control part of the document management apparatus receives the user access information including the business relevancy information of the application user and determines based at least in part on the business relevancy information of the application user, the extent of data accessible by the application user in the document database.

6. The system of claim 1, wherein
the document management apparatus further includes an application program interface configured to specify to the application user interface apparatus a format to be used for communication by the application user interface apparatus with the document management application, and
the operations user interface part of the application user interface apparatus conforms the search command to the format specified by the application program interface of the document management apparatus.

7. The system of claim 1, wherein the user authentication part of the application user interface apparatus supplies a login user interface through the network to the terminal for the application user to login.

8. The system of claim 1, wherein the operations user interface part supplies the search user interface through the network to the terminal for the application user to supply the one or more key terms, and transmits the search results through the network to the terminal.

9. The system of claim 1, wherein the user authentication part of the application user interface apparatus provides a login interface on a multi-function device for the application user to login.

10. The system of claim 1, wherein the operations user interface part supplies the search user interface on the multi-function device for the application user to supply the one or more key terms, and causes the search results to be displayed on a display of the multi-function device.

11. A document access apparatus configured to access a document management application including a plurality of application functionalities through a network, the application functionalities including a document registration function to register a specified document in a document database, and a search function to search the document database based on specified terms, said document access apparatus comprising:
a user authentication part configured to maintain, for each particular one of a plurality of users, user access information corresponding to the particular user, and receive and utilize user information from login of an application user to perform user authentication of the application user and retrieve the user access information maintained for the application user; and
an operations user interface part configured to receive one or more key terms entered by the application user for a search, the operations user interface part including a search interface to communicate with the document management application to perform the search based on the one or more key terms,
the operations user interface part providing, to the application user, search results that include only documents or document data that are within the extent of the data accessible by the application user in the document database, as indicated by the data access at on included in the user access information retrieved by said user authentication part,
wherein the search results provided to the application user do not include documents or document data that are not within the extent of the data accessible by the application user.

12. The document access apparatus of claim 11, wherein the search interface communicates the user access information along with the one or more key terms, through the network, to the document management application, and receives through the network from the document management application the search results that include only the documents or document data that are within the extent of the data accessible by the application user and does not return the documents or document data that are not within the extent of the data accessible by the application user.

13. The document access apparatus of claim 11, wherein the search interface communicates a search command and the one or more key terms to the document management application, receives from the document management application results of the search performed by the document management application, and the search interface filters, based on the user access information, the results received from the document management application to obtain the search results that do not include documents or document data that are not within the extent of the data accessible by the application user.

14. The document access apparatus of claim 11, wherein the user access information maintained by the user authentication part for the particular user includes data access information indicating the extent of data that is accessible by the particular user from a document database through the document management application.

15. The document access apparatus of claim 11, wherein
the user access information maintained by the user authentication part for the application user further includes document parameters information indicating specified document parameters available to the application user for specifying a search to be performed, the specified document parameters not including at least one document parameter maintained for documents in the document database by the document management application, and
the operations user interface part provided to the application user for specifying the search allows for the application user to select from the specified document parameters, and not from other document parameters maintained for documents in the document database by the document management application.

16. The document access apparatus of claim 15, wherein the specified document parameters are selected by the application user through the operations user interface as a subset of all of the document parameters maintained for documents in the document database by the document management application, and the subset of selected document parameters are registered as the document parameters information for the application user.

17. The document access apparatus of claim 11, wherein
the user access information maintained by the user authentication part for the application user includes business relevancy information indicating a specific business relevancy field pertinent to the application user, and
the search interface determines, based at least in part on the business relevancy information of the application user, the extent of data accessible by the application user in the document database.

18. The document access apparatus of claim 17, wherein the search user interface processes the search results received from the document management application, in accordance with the determination of the extent of data accessible by the application user based on the business relevancy information of the application user, to generate processed search results that do not include documents or document data that are not within the extent of the data accessible by the application user.

19. The document access apparatus of claim 11, wherein the operations user interface part of the document access apparatus communicates, when user input is received through a search user interface provided by the operations user interface part, with an application program interface of the document management application, and sends the search command, the one or more key terms and the user access information of the application user to the document management application, in accordance with format information received from the application program interface.

20. A method for streamlining access in a document management system, said method comprising the steps of:
(a) maintaining, by an application user interface apparatus, user access information for a plurality of specific users, the user access information for each one of the plurality of specific users including data access information indicating an extent of data accessible by the specific user in a document database maintained by the document management system;
(b) receiving, by the application user interface apparatus, user information during login of an application user, performing user authentication of the application user, and utilizing the user information to retrieve the user access information maintained in (a) for the application user; and
(c) providing, by the application user interface apparatus, a search user interface to receive user entry of one or more key terms for a search;
(d) communicating, by the application user interface apparatus, a search command, the one or more key terms and the user access information of the application user through a network to a document management application in the document management system, to perform the search based on the one or more key terms; and
(e) providing, by the application user interface apparatus, to the application user, search results that include only documents or document data that are within the extent of the data accessible by the application user in the document database, as indicated by the user access information of the application user, wherein the search results provided to the application user do not include documents or document data that are not within the extent of the data accessible by the specific user.
